(19) United States
(12) Patent Application Publication
(10) Pub. No.: US 2022/0387969 A1
(43) Pub. Date: Dec. 8, 2022

(54) Synthesis Process for Solid Carbon Capture Materials

(71) Applicants: THE REGENTS OF THE UNIVERSITY OF COLORADO, A BODY CORPORATE, Denver, CO (US); ARIZONA BOARD OF REGENTS ON BEHALF OF ARIZONA STATE UNIVERSITY, Scottsdale, AZ (US)

(72) Inventors: Alan W. WEIMER, Niwot, CO (US); Annika LAI, Boulder, CO (US); Robert PFEFFER, Scottsdale, AZ (US); Jerry LIN, Scottsdale, AZ (US)

(21) Appl. No.: 17/775,992

(22) PCT Filed: Nov. 11, 2020
(86) PCT No.: PCT/US2020/060013

§ 371 Date: May 11, 2022

Related U.S. Application Data
(60) Provisional application No. 62/933,845, filed on Nov. 11, 2019.

(51) Int. Cl. B01J 20/22; B01J 20/10; B01J 20/28; B01J 20/32; B01D 53/62; B01D 53/81

(52) U.S. Cl. CPC B01J 20/22; B01J 20/103; B01J 20/28016; B01J 20/3204; B01J 20/3293; B01J 20/3219; B01J 20/3257; B01D 53/62; B01D 53/81; B01D 2253/20; B01D 2253/25; B01D 2257/504

(57) ABSTRACT

A method for forming an amine-functionalized solid CO₂ sorbent for carbon capture may include providing a support material and applying at least one cycle of molecular layer deposition (MLD) with an amine precursor onto the surface of the support material. An amine layer formed on the support material contains amine groups/amine-containing ligands to adsorb CO₂ onto the support material in a low temperature operating window for adsorption and desorption without the loss of active sites.

### CROSS-REFERENCE TO RELATED APPLICATION

This application claims the benefit of and priority to U.S. Provisional Patent Application Ser. No. 62/933,845, filed Nov. 11, 2019 and entitled SYNTHESIS PROCESS FOR SOLID CARBON CAPTURE MATERIALS, which is incorporated herein by reference in its entirety.

### BACKGROUND

Advancing economic and sustainable technologies in the energy sector has led to an increased focus on carbon capture by both energy producers and regulators concerned with mitigating carbon dioxide (CO₂) emissions and accumulation in the atmosphere. With over half of the world's energy generated from the combustion of fossil fuels, the demand for developments in CO₂ capture technology has surged over the last decade. Carbon capture generally includes the capturing, sequestering, storing, disposing of, or entraining CO₂, with the end goal of converting captured CO₂ into value-added products, and is seen as essential to increasing both the economic and environmental viability of carbon-rich fossil fuels as well as for reducing the accumulation of greenhouse gases and the related effects of global climate change.

The dominating technology for carbon capture is an amine mechanism, which has proven to be the most cost-effective and developed category of material for sequestering CO₂ at both high and low concentrations. Liquid amines, including monoethanolamine and diethanolamine, are currently used for industrial scale scrubbing of carbon dioxide-containing gas, such as for adsorption of CO₂ from flue gas. Current applications of this technology are limited by an energy-intensive regeneration process (as high as 3.9 GJ/tCO₂ for an MEA system) and corrosion effects, which increase the cost and reduce the commercial viability of capturing CO₂. Aqueous sorbents capture CO₂ by chemical absorption of CO₂ to form carbonates, thereby requiring high energy for releasing CO₂ in a separate stripper column.

Solid adsorbents that adsorb CO₂ by chemisorption present a feasible alternative to aqueous sorbents because of their significantly lower heat capacity and ability to adsorb at low concentrations. Thermal cycling to regenerate solid sorbents requires little energy input compared to that of liquids. The ability to regenerate adsorbents at a low temperature range also allows for the favorable release of CO₂ which can be stored via sequestration or utilized by chemically converting it into value-added products such as small hydrocarbons, methanol, or formic acid.

Existing efforts to create functionalized solid substrates with amine groups/networks for the application of carbon capture adsorption involve amine-immobilized sorbents. Types of amine supports contemplated for solid carbon capture sorbents include silica-based substrates, alumina, titanium, zirconia, metal-organic frameworks, polymers, carbon nanotubes/fibers, zeolites, carbon black, carbon particles and/or activated carbon. Known amine functionalization methods include impregnation, grafting, in situ polymerization and others, however these methods are disadvantaged by a need for specially prepared and expensive substrates, increased manufacturing complexity and costs, and/or a loss of amine active sites during regeneration, among other challenges.

A particular challenge in conventional functionalized substrates is the preparation of the substrate surface for receiving amine active sites. As is generally understood in the art, functionalization of a given substrate may be limited by the extent of its surface area, more particularly the extent of its surface area that is able to be functionalized. The use of smaller, porous particle substrates could hypothetically increase the functionalization and adsorption capabilities of a sorbent, however conventional functionalization methods generally rely on liquid phase deposition or functionalization which cannot sufficiently coat or functionalize smaller particles, particularly those having small pores, and may involve complicated and cost intensive substrate preparation methods. Commercial viability of conventional solid CO₂ sorbents remains a significant obstacle in the development of carbon capture.

Improving the regeneration efficiency and reducing the manufacturing costs for solid adsorbents continues to be an active research area, with investigation into alternative support materials and adsorbents being a primary area of interest. While some advantages have been realized through the preparation of these alternative and specialized materials, cost effective methods for achieving improved regeneration efficiency without forfeiting effective carbon capture have proven elusive.

There remains a need for an improved process for creating reliable and efficient carbon capture materials, without increasing the cost or complexity of manufacture and use. Of particular interest would be a process enabling the use of inexpensive and commonly available materials in solid CO₂ sorbents.

### SUMMARY

Embodiments of the present disclosure are directed to improved amine-functionalized, solid CO₂ sorbents and related methods of manufacture and use.

According to embodiments of the disclosure, the amine-functionalized solid CO₂ sorbent is one which facilitates amine deposition and improves anchoring between a sorbent substrate and precursor molecules, particularly for use in carbon capture adsorption and/or other adsorption reliant methods and devices. An advantage of the amine deposition performed by methods of the disclosure is the superior uniformity and distribution of an amine layer coating, even on very small and porous substrate particles, thereby increasing the functionalized surface area of the particles without requiring specialized substrates or complicated manufacturing processes. The solid CO₂ sorbents of the disclosure have been found to achieve the advantages of improved amine deposition while preserving a favorable regeneration of amine active sites upon desorption, rather than the loss of active sites as may occur in some conventional solid CO₂ sorbents. In like manner, the steps of the disclosed method have advantageously been discovered to be effective for the preparation of solid CO₂ sorbents using inexpensive and commonly available materials, without complicated and costly preparation of those materials.

In at least one embodiment, a method of forming an improved amine-functionalized, solid CO₂ sorbent is provided. The method includes providing a support material and applying an amine layer onto at least a portion of a surface of the support material. In various embodiments of the disclosure, the application of the amine layer onto at least the portion of the surface of the support material may be performed by one or more cycles, or surface reaction steps, of molecular layer deposition (MLD) or atomic layer deposition (ALD). The use of MLD to synthesize the amine-functionalized solid CO₂ sorbent allows for angstrom-level thickness control during film growth and covalent anchoring between the substrate and precursor molecules.

MLD is a gas-phase deposition technique that relies on self-limiting surface reactions to allow for precise film growth on a particle surface. The gas-phase nature of MLD enables the coating of smaller and more porous particles with an amine layer, such as silica-based nano-powders, expanding the surface area of the solid sorbent that may be functionalized for carbon capture. The use of MLD according to described methods of the disclosure likewise facilitates the use of a wider range of substrate materials for solid CO₂ sorbents, and that without specialized surface preparation methods, than was conventionally understood. Covalent bonding between the substrate and precursor according to the MLD-based method advantageously ensures the regeneration of amine active sites upon desorption, rather than the loss of active sites as occurs with some conventional solid sorbents. No previous studies have performed MLD, or ALD, depositing amine functional groups on a substrate for production of solid CO₂ capture materials.

Conventional methods for synthesizing amine-functionalized solid CO₂ sorbents include impregnation, grafting, in situ polymerization and other known liquid-phase based reactions, which are disadvantaged by high costs, liquid waste streams, and complicated manufacturing methods. In addition, utilization of these conventional methods can limit the range of substrate materials available or reduce the effectiveness and durability of the sorbents produced, providing limited benefits relative to aqueous sorbents due to these challenges. By processing the sorbent according to the particular methods described in the current disclosure, it is possible to take advantage of a wider range of support materials for solid CO₂ sorbents, an improved amine deposition reaction occurring in the gas-phase, as well as covalent bonding between the support material and the amine precursors to improve stabilization of amine active sites during desorption while maintaining the advantages of lower energy requirements and reduced corrosivity effects relative to known sorbents.

According to varying embodiments, methods of the instant disclosure may allow for increased control in the application of amine active sites to the substrate and corresponding fine-tuning of the sorbent properties relative to prior art methods. For example, methods of the disclosure may allow for the creation of a uniform monolayer film of amine active sites on the substrate material. The amine layer may form a continuous film coating the entirety of a substrate surface, which may be particularly advantageous when used with a porous substrate for increasing surface area available for chemisorption of CO₂. Similarly, the self-limiting nature of the reaction steps of the method allow for a precise control of the extent and thickness of the amine layer.

In at least one embodiment, the method of forming an amine-functionalized solid CO₂ sorbent may include MLD of an alkylamine network on a support material by alternating a first precursor and a second precursor. According to an embodiment, the first precursor may comprise an amine precursor, such as aminopropyl-silane molecules, and the second precursor may include water. Aminopropyl-silane molecules including aminopropyltriethoxysilane (mono-amine or APTS), N¹-(3-trimethoxysilylpropyl) diethylene triamine, or tri-amine, and N-[3-(trimethoxysilyl) propyl]ethylenediamine, or di-amine, may be advantageous for use as the first precursor in new amine MLD chemistries according to the current disclosure.

The support material may include silica-based support materials, such as fumed silica, silica fume, porous and mesoporous silica, silica gel, silica aerogel, silica nanotubes, and silica foam, or may include alumina, titanium, zirconia, metal-organic frameworks, polymers, carbon nanotubes/fibers, zeolites, carbon black, carbon particles and/or activated carbon. The support material may be provided in the form of a porous substrate and/or in the form of substrate particles, the substrate presenting either a substantially uniform or non-uniform surface area for receiving the first precursor and the second precursor.

In advantageous embodiments, the support material may comprise a nano-powder material having a total size in the range of 1 nm to 100 nm. The use of nano-powders, or nano-powder agglomerates, as support materials advantageously results in an enormous increase in functionalized surface area relative to larger particles used in conventional sorbents. While particles of such a small size have not previously been successfully adapted for use in solid CO₂ sorbents, or at least not in a commercially viable and operationally effective manner, the methods of the current application have realized a simple functionalization of nano-powder substrates that is able to saturate the surface of said nano-powders with amines.

In at least one aspect, MLD according to embodiments of the disclosure may functionalize the support material with amine groups/amine-containing ligands to adsorb CO₂ by the carbamate mechanism or the formation of carbamic acid. Amine functionalized adsorbents also allow for a low temperature operating window for adsorption and desorption. Adsorption occurs in the range of about 25° C. to 85° C. and desorption occurs from about 60° C. to 150° C.

The amount of amine deposited on the support material may be controlled by the number of MLD cycles and configured to the size and material properties of a given substrate. One MLD cycle may include the sequential exposure of the first precursor and the second precursor to the support material with purges in-between, such as with nitrogen gas. According to an embodiment, the method may include at least 1 cycle of MLD, at least 5 cycles, at least 10 cycles, at least 15 cycles, or at least 20 cycles.

Increasing MLD cycle number may advantageously increase nitrogen weight percent, monolayer uptake (μmol CO₂/g sorbent), and adsorption capacity (mmol CO₂/g sorbent) relative to conventional amine-functionalized sorbents. Higher-cycle sorbents (10 and 15) according to the current disclosure adsorb considerable amounts of CO₂, which is confirmed by both chemisorption monolayer uptake measurements and absolute adsorption capacity measurements, such as shown in the experimental examples of the instant disclosure. An additional advantage of methods of the present disclosure is an increased precision in the thickness of the applied amine layer, as an increased MLD cycle number corresponding to an increasing thickness of the amine layer generally increases adsorption capacity but with the possibility of eventually diminishing returns. By applying the amine layer using precise MLD cycles, improved adsorption capacity may be achieved with reduced production costs.

MLD-synthesized sorbents formed according to methods of the disclosure advantageously demonstrate an ability to remain stable during thermal cycling between the desorption and adsorption temperature ranges, i.e. the adsorption active sites are regenerated during the desorption step with the ability to adsorb multiple times, relative to sorbents formed using prior art methods. This advantage may be realized at least in part due to the covalent bonds formed during MLD of the amine layer to the support material. Sequential MLD cycles form chemical bonds within the amine layer, increasing the stability of the amine layer during thermal cycling between the desorption and adsorption temperature ranges.

An embodiment of the current disclosure includes a functionalized solid sorbent created by the methods described above. According to an embodiment, the functionalized solid sorbent comprises a support material and an amine layer. The support material may include silica-based support materials, such as fumed silica, silica fume, porous and mesoporous silica, silica gel, silica aerogel, silica nanotubes, and silica foam, or may include alumina, titanium, zirconia, metal-organic frameworks, polymers, carbon nanotubes/fibers, zeolites, carbon black, carbon particles and/or activated carbon. The support material may be provided in the form of a porous substrate and/or in the form of substrate particles, the substrate presenting either a substantially uniform or non-uniform surface area for receiving an amine layer in the form of amine groups deposited on the support material as a CO₂ adsorption material.

The functionalized solid sorbent may be provided in the form of sorbent particles or as a larger substrate material. In embodiments, the functionalized solid sorbent may comprise an amine functionalized nano-powder having a total size in the range of 1 nm to 100 nm. Similarly, the functionalized solid sorbent may include a surface area of the support material coated and/or fully saturated with the amine layer, said surface area defined by an exterior surface of the support material and an interior surface of pores formed within the support material. According to varying embodiments, the amine layer may form a continuous and/or uniform film on the support layer or on the surface area of the support material.

Further embodiments may include related methods and devices for using a functionalized solid sorbent for carbon capture.

The above embodiments solve the problem of existing amine functionalization methods requiring the use of specialized substrate materials, complicated and expensive manufacturing methods, or which lose amine active sites during regeneration. Specifically, the above embodiments allow for an improved functionalization of cheaper substrate materials with an increased surface area, such as in the form of nano-powders or nano-powder agglomerates, without increasing the cost or complexity of manufacture and use.

Features from any of the disclosed embodiments may be used in combination with one another, without limitation. For example, any of the compositional limitations described with respect to one embodiment may be present in any of the other described embodiments. In addition, other features and advantages of the present disclosure will become apparent to those of ordinary skill in the art through consideration of the following detailed description and the accompanying drawings.

### BRIEF DESCRIPTION OF THE DRAWINGS

FIG. 1 shows a schematic flow chart of a method of forming an improved amine-functionalized, solid CO₂ sorbent according to an embodiment of the disclosure.

FIG. 2 shows a chemical reaction diagram of a method of forming an improved amine-functionalized, solid CO₂ sorbent according to an embodiment of the disclosure

FIG. 3 is a simplified, schematic cross-sectional view of an improved amine-functionalized, solid CO₂ sorbent according to an embodiment of the disclosure.

FIG. 4 shows chemical structures of aminopropyl-silane molecules aminopropyltriethoxysilane (mono-amine or APTS), N¹-(3-trimethoxysilylpropyl) diethylene triamine (tri-amine), and N-[3-(trimethoxysilyl) propyl] ethylenediamine (di-amine).

FIG. 5 is a schematic plan view of an MLD fluidized bed reactor system according to an embodiment of the disclosure.

FIG. 6 shows the results of a simplified mass spectrometry trace for a single cycle of mono-amine MLD according to an embodiment of the disclosure.

FIG. 7 shows the results of a simplified mass spectrometry trace for a single cycle of tri-amine MLD according to an embodiment of the disclosure.

FIG. 8 shows nitrogen content in weight percent versus a mono-amine/water MLD cycle number according to an embodiment of the disclosure.

FIG. 9 shows a comparison of the nitrogen content of a functionalized substrate after 10 MLD cycles with mono-amine versus the nitrogen content of a functionalized substrate after 10 MLD cycles with tri-amine, according to some embodiments of the disclosure.

FIG. 10 shows the results of thermogravimetric analysis for thermal cycling between CO₂ adsorption and desorption temperatures for 25 cycles of a functionalized substrate after 10 MLD cycles with mono-amine versus a functionalized substrate after 10 MLD cycles with tri-amine, according to some embodiments of the disclosure.

FIG. 11 shows the results of Quantachrome Gas Sorption Analyzer CO₂ monolayer uptake measurements for uncoated (before undergoing MLD functionalization), 5-cycle, and 10-cycle samples of a mono-amine functionalized substrate according to some embodiments of the disclosure.

FIG. 12 shows thermogravimetric analysis curves of weight % of sorbent sample vs. time at transition from inert environment to CO₂ introduction for a functionalized substrate after 10 MLD cycles with mono-amine, a functionalized substrate after 10 MLD cycles with tri-amine, and a functionalized substrate after 15 MLD cycles with tri-amine, according to some embodiments of the disclosure.

FIG. 13 shows calculated CO₂ adsorption capacities for uncoated, 5-cycle, and 10-cycle samples of a mono-amine functionalized substrate according to the embodiments of FIG. 12.

The drawings and figures are not necessarily drawn to scale, unless otherwise indicated, but instead are drawn to provide a better understanding of the components, and are not intended to be limiting in scope, but to provide exemplary illustrations.

### DETAILED DESCRIPTION OF VARIOUS EMBODIMENTS

To further clarify the above and other advantages and features of the present disclosure, a more particular description will be rendered by reference to specific embodiments thereof, which are illustrated in the appended drawings. It is appreciated that these drawings depict only typical embodiments of the disclosure and are therefore not to be considered limiting of its scope. The present disclosure will be described and explained with additional specificity and detail through the use of the accompanying drawings, in which like reference characters refer to like elements.

It is to be understood that disclosure is not limited to the specific embodiments and methods described below, as specific components and/or conditions may, of course, vary. Furthermore, the terminology used herein is used only for the purpose of describing particular embodiments and is not intended to be limiting in any way.

Except in the examples, or where otherwise expressly indicated, all numerical quantities in this description indicating amounts of material or conditions of reaction and/or use are to be understood as modified by the word “about” in describing the broadest scope of the disclosure. Also, unless expressly stated to the contrary: description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation; and, unless expressly stated to the contrary, measurement of a property is determined by the same technique as previously or later referenced for the same property.

It must also be noted that, as used in the specification and the appended claims, the singular form “a,” “an,” and “the” may comprise plural references unless the context clearly indicates otherwise. For example, reference to a component in the singular is intended to comprise a plurality of components.

The terms “substrate,” “support material,” and the like are used interchangeably in the specification and may be commonly understood as a carrier material having a surface area available for functionalization.

As discussed above, existing functionalization methods suffer from high costs, a limited range of effective substrate materials, and complex and sensitive manufacturing processes. Conventional solid CO₂ sorbents may provide only limited functionalization of available surface area and/or suffer the loss of amine active sites during regeneration. Embodiments of the present disclosure provide an improved amine-functionalized, solid CO₂ sorbent that offers a proven reduction in energy requirements for regeneration of active sites while increasing durability and long-term stability at a lower cost than conventional solid sorbents. The advantages, including regenerative, durability and cost saving properties, of the disclosed amine-functionalized, solid CO₂ sorbent may be due to the preparation methods used, and embodiments of the disclosure include methods for forming the disclosed amine-functionalized, solid CO₂ sorbent, including related methods of use.

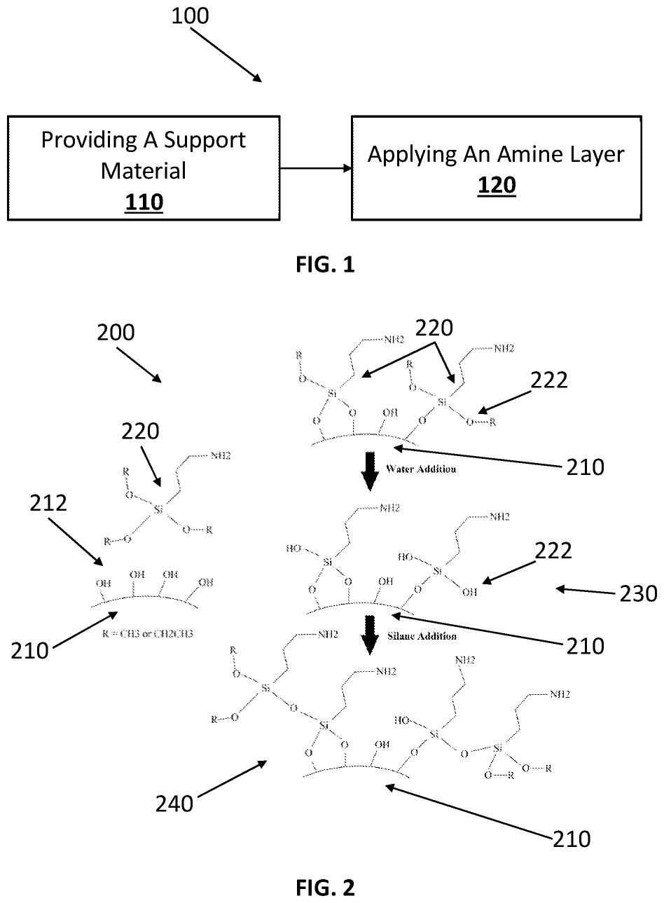

Referring now to FIG. 1, a method 100 of forming an improved amine-functionalized, solid CO₂ sorbent according to an embodiment of the disclosure is shown schematically in a flow chart. The method 100 may include providing a support material at step 110. The support material may be a conventional amine support material or another support material. According to various embodiments, the support material may comprise silica-based support materials, such as fumed silica, silica fume, porous and mesoporous silica, silica gel, silica aerogel, silica nanotubes, and silica foam, or may comprise alumina, titanium, zirconia, metal-organic frameworks, polymers, carbon nanotubes/fibers, zeolites, carbon black, carbon particles and/or activated carbon. In embodiments, the support material may be provided in a powdered form, such as in the form of a nano-powder or nano-powder agglomerate.

The method 100 may include the step 120 of applying an amine layer onto at least a portion of a surface of the support material. In various embodiments of the disclosure, the application of the amine layer onto at least the portion of the surface of the support material may be performed by one or more cycles, or surface reaction steps, of MLD or ALD.

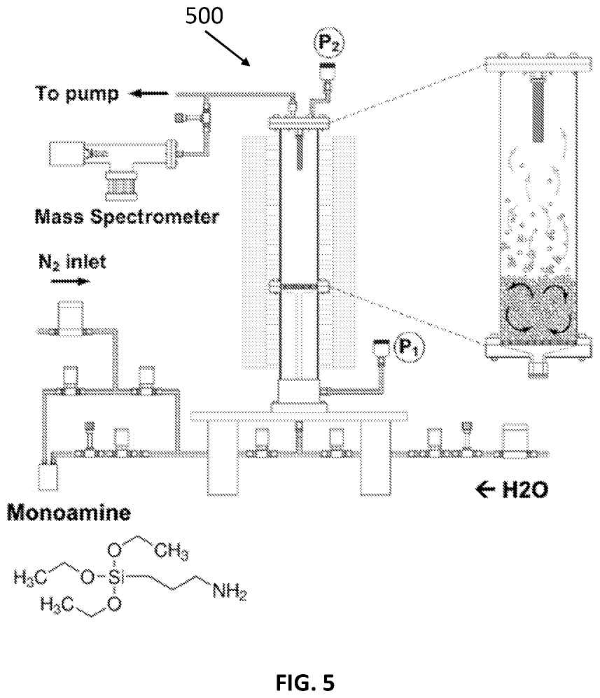

In one embodiment, active sites may be added to the support material using a first precursor and a second precursor as alternating reagents, for example in a fluidized bed reactor 500 as illustrated in FIG. 5 or using a similar system or device. In the example of a fluidized bed reactor, the first and the second precursor may be passed through the solid support material at high speeds in order fluidize, or suspend and cause to behave as a fluid, the solid support material. When fluidizing the solid support material, the fluidization can be assisted by mechanical vibration, pulsing of the gas, by adding downward facing micro-nozzles above the distributor to produce microjets at very high velocity, or by another means as would be understood by one skilled in the art from the present disclosure.

In methods of the disclosure, a first precursor and a second precursor dose may be applied as sequential half-cycles in a single MLD cycle. The reactor may be purged between half-cycles, such as with nitrogen gas (N2) or an inert gas, with the first precursor and the second precursor acting as alternating reagents. The first precursor and the second precursor may be applied separately at a reactor bed temperature between 130° C. to 170° C., or at least 130° C.

The first precursor may comprise an amine precursor, such as aminopropyl-silane molecules, and the second precursor may include water. Aminopropyl-silane molecules comprise at least aminopropyltriethoxysilane (mono-amine or APTS), N¹-(3-trimethoxysilylpropyl) diethylene triamine, or tri-amine, and N-[3-(trimethoxysilyl) propyl] ethylenediamine, or di-amine, as shown in FIG. 4. Additional amine precursors may be employed in the method, as would be understood from the current disclosure by one skilled in the art.

The use of MLD for applying the amine layer advantageously allows for angstrom-level thickness control over the growth on the support material and the amine layer may be formed homogenously on the support material such that amine active sites are present evenly across the surface of the support material with the amine layer. In like manner, the use of gas-phase precursors in the described methods may advantageously allow for a complete saturation or coating of the support material with an amine layer, even in porous and very small particles.

Methods of the instant disclosure allow for increased control in the application of amine active sites to the substrate and corresponding fine-tuning of the sorbent properties relative to prior art methods. The controlled application of the amine layer by at least 1 cycle of MLD, at least 5 cycles, at least 10 cycles, at least 15 cycles, or at least 20 cycles, allows for precise control of the thickness of the amine layer and resulting amine active sites in the CO₂ sorbent. As would be recognized by one skilled in the art from the present disclosure, the step 120 of applying an amine layer onto at least a portion of a surface of the support material may include a plurality of MLD cycles or may include a single cycle where the step 120 may be repeated to achieve a desired thickness of the amine layer.

According to an embodiment of the method, application of an amine layer may be exemplified by the chemical reaction diagram illustrated in FIG. 2. In the method 200, a silica-based support material 210 may be provided including hydroxyl groups 212 on a silica surface. Aminosilane molecules 220 may be introduced to the silica surface as the first precursor, where reactions occur between the aminosilane molecule 220 and the hydroxyl groups 212, forming ethanol or methanol as a byproduct depending on the alkoyy group (R) present on the aminosilane.

Introduction of water as the second precursor causes a reaction between the water and alkoxy groups 222 of the deposited amine molecule 220 to produce ethanol or methanol as a leaving group and produces additional hydroxyl groups to react with the first precursor in a subsequent cycle.

In a resulting 1-cycle amine functionalized solid sorbent 230, the aminopropyltriethoxysilane molecules 220 are covalently bonded to the silica surface and provide amine active sites for adsorption and hydroxyl groups for the introduction of another MLD cycle of aminosilane molecules and water, such as for forming a 1.5-cycle amine functionalized solid sorbent 240.

As would be recognized from the amine-functionalized solid sorbents illustrated in FIG. 2, methods of the present disclosure provide an improved functionalization of the support material with an amine layer that is covalently bonded and includes a greater number of active sites for carbon capture relative to conventional functionalization methods.

According to differing embodiments, the amine of the first precursor may be maintained from one cycle of MLD to the next or the amine of the first precursor may be changed between cycles for the formation of different alkylamine networks. In an example of the methods of the disclosure, a uniform monolayer film of amine active sites may be formed on the substrate material. The amine layer may form a continuous film coating the entirety of a substrate surface, which may be particularly advantageous when used with a porous substrate for increasing surface area available for chemisorption of CO₂, or may be controlled to form a discontinuous film on predetermined areas of the support material.

Similarly, the self-limiting nature of the reaction steps of the method allow for a precise control of the amine layer thickness, such that the thickness of the amine layer may be increased to maximize adsorption capacity. In an example, the surface area of the support material may be completely saturated with amines, such that steric hindrance prevents the introduction of additional amines. Similarly, the method may be precisely controlled to maximize adsorption capacity of the support material without diminishing returns that may result from over-application of the amine layer, such as by filling pores in the support material that may reduce adsorption due to diffusion limitations.

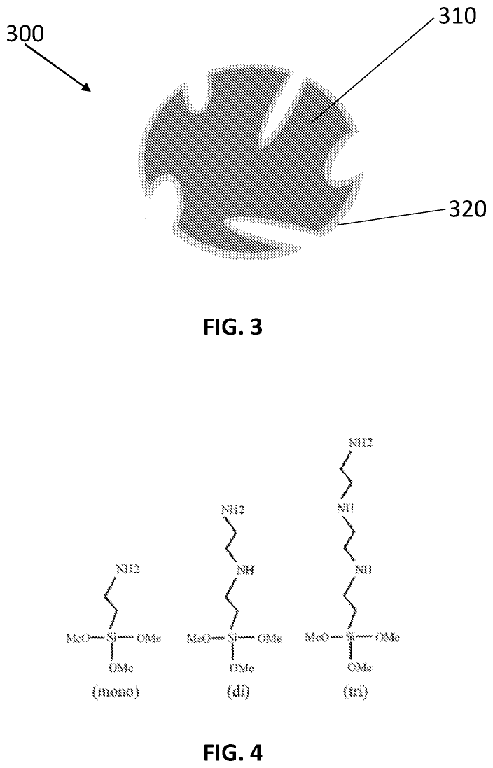

As shown in the simplified, schematic cross-sectional view of FIG. 3, an embodiment of the current disclosure includes an amine-functionalized solid CO₂ sorbent, such as formed by methods of the current disclosure. The sorbent 300 includes a support material 310 and an amine layer 330 overlying the support material 310, as schematically illustrated in FIG. 3. While shown in simplified form in FIG. 3, the support material 310 may include particles, porous materials, and may be configured with any suitable shape or size for use in carbon capture applications and methods. In like manner, the amine layer 330 may be formed as a continuous and/or uniform film and may be arranged to completely coat any exposed surface area of the support material 310, including within pores of the support material 310. In alternative embodiments, the amine layer 330 may be applied as a discontinuous film on the support material 310 or as a film on predetermined portions of the support material 310.

The support material 310 may include silica-based support materials, such as fumed silica, silica fume, porous and mesoporous silica, silica gel, silica aerogel, silica nanotubes, and silica foam, or may include alumina, titanium, zirconia, metal-organic frameworks, polymers, carbon nanotubes/fibers, zeolites, carbon black, carbon particles and/or activated carbon. The support material may be provided in the form of a porous substrate and/or in the form of substrate particles, the substrate presenting either a substantially uniform or non-uniform surface area for receiving an amine layer in the form of amine groups deposited on the support material as a CO₂ adsorption material.

According to varying embodiments, the support material may be a chemically unmodified or commonly available substrate material. In one example, the support material may comprise fumed silica or silica fume as is widely available commercially at a very low cost much less than the cost of specialized substrates, for example silica aerogel. The use of common silica materials dramatically reduces the cost of amine-functionalized solid CO₂ sorbents of the present application relative to conventional solid CO₂ sorbents, and the methods and products according to the disclosed embodiments can therefore be far more commercially viable than existing solid CO₂ sorbents that require specialized substrates, costly preparation methods, and complicated manufacturing processes.

The support material may comprise a nano-powder material having an individual particle size in the range of 1 nm to 100 nm, in another example having an individual particle size in the range of 1 nm to 20 nm. The use of nano-powders as support materials advantageously results in an enormous increase in functionalized surface area relative to larger particles used in conventional sorbents. When fluidized, nano-powders may form large agglomerates on the order of 100 μm which are extremely porous. While individual nanoparticles cannot be fluidized, ALD and MLD methods are able to coat the surface of each individual nanoparticle in the fluidized porous agglomerates. While particles of such a small size have not previously been successfully adapted for use in solid CO₂ sorbents, or at least not in a commercially viable and operationally effective manner, the methods of the current application have realized a simple functionalization of nano-powder substrates that is able to saturate the surface of said nano-powders or nano-powder agglomerates with amines.

In one example, the support material may comprise a silica-based nano-powder. Silica nano-powders have the benefit of an incredibly high surface area due to the large area/volume ratio of the material. The larger the surface area of the particles, the greater the number of hydroxyl groups present for functionalization. Methods of the present disclosure present the further benefit of precisely controlled, gas-phase deposition, advantageously enabling functionalization of a greater surface area of the support material than may be achieve in conventional methods.

In embodiments, a surface of the support material 310 may be completely saturated with amine groups of the amine layer 330. The functionalized solid sorbent may include a surface area of the support material coated with the amine layer, said surface area defined by an exterior surface of the support material and an interior surface of pores formed within the support material. According to varying embodiments, the amine layer may form a continuous and/or uniform film on the support layer or on the surface area of the support material.

In varying examples, the amine-functionalized solid CO₂ sorbent may include a nitrogen weight percent of at least 1.00%, at least 1.25%, or preferably at least 1.40%, the nitrogen content being proportional to the number of amine groups in the amine layer 330.

The amine-functionalized solid CO₂ sorbent may be configured with an adsorption capacity of at least 1.00 mmol CO₂/g sorbent, at least 1.50 mmol CO₂/g sorbent, at least 1.80 mmol CO₂/g sorbent, at least 2.00 mmol CO₂/g sorbent, at least 2.50 mmol CO₂/g sorbent, or at least 3.00 mmol CO₂/g sorbent. No similar adsorption capacity has been previously realized using MLD produced solid CO₂ sorbents, and especially not using nano-powder support materials.

Surprisingly, it has been discovered that amine-functionalized solid CO₂ sorbents according to the present disclosure have the ability to regenerate amine active sites through cycles of adsorption and desorption without any noticeable depletion in amine groups. Accordingly, the amine-functionalized solid CO₂ sorbents have an increased durability and useful life relative to conventional solid sorbents, allowing the advantage of low energy regeneration in industrial use without the increased costs associated with replacing depleted conventional sorbents.

### EXPERIMENTAL EXAMPLES

The following experimental examples are provided to illustrate an embodiment of the current disclosure and to more particularly demonstrate the advantages of the embodiments but are not intended to limit the scope thereof.

In experimental examples according to some embodiments of the method, samples of various cycle numbers, using MLD of both mono- and tri-amine molecules, were synthesized. FIG. 5 provides a schematic of a stainless-steel fluidized bed reactor (FBR) system that may be used in sorbent synthesis. Related systems and devices may be employed for the disclosed methods, as would be understood by one of ordinary skill in the art from the instant description. MLD of each amine precursor molecule was carried out separately with water at a reactor bed temperature of 150° C. and an amine bubbler temperature of 90° C. The amine molecule and water acted as alternating reagents.

One MLD cycle of each chemistry included the sequential exposure of the aminopropyl-silane molecule and water with inert nitrogen purges in-between. CAB-O-SIL untreated fumed silica (SiO₂) from Cabot was used as the substrate. About 3 grams of fumed (nano) SiO₂ was loaded into the MLD reactor and coated with 1, 3, 5 and 10 cycles of mono-amine MLD, and 10 and 15 cycles of tri-amine MLD to vary film thickness and amine group deposition. An in-line mass spectrometer (Stanford Research Systems) attached to the reactor system monitored exiting gases.

Sorbents were characterized by nitrogen content (weight percent), thermal cyclic stability, monolayer uptake measurements, and absolute adsorption capacity. Nitrogen weight percent for each sample was obtained by LECO elemental analysis using approximately five to eight mg of each sample. Thermal cyclic stability tests were conducted using thermogravimetric analysis (TGA) to cycle between 80° C. and 30° C. At 80° C., the sample was held under pure argon for one hour. At 30° C., the sample was held under diluted CO₂ (60% by volume) in argon for 30 minutes.

This cycle was repeated 25 times. Monolayer uptake measurements of the mono-amine were obtained using a Quantachrome Gas Sorption Analyzer and 30 to 40 mg of sample in a pure CO₂ atmosphere for 30 minutes at 30° C.

Monolayer uptake data refers to μmol CO₂/g sorbent physisorbed to the surface of the sample. Monolayer uptake is a similar measurement to adsorption capacity but is less indicative of the sorbent's actual capacity because of the test's stagnant gas environment that is unlikely to be seen in industrial applications. Therefore, absolute adsorption capacity measurements were taken using TGA under flowing inert and reactive gases. The sequential steps for each measurement included sorbent activation at 105° C. under pure argon for one hour followed by exposure to 40% (by volume) CO₂ in argon at 30° C. for one hour and 26 minutes (equivalent to pure CO₂ for one hour).

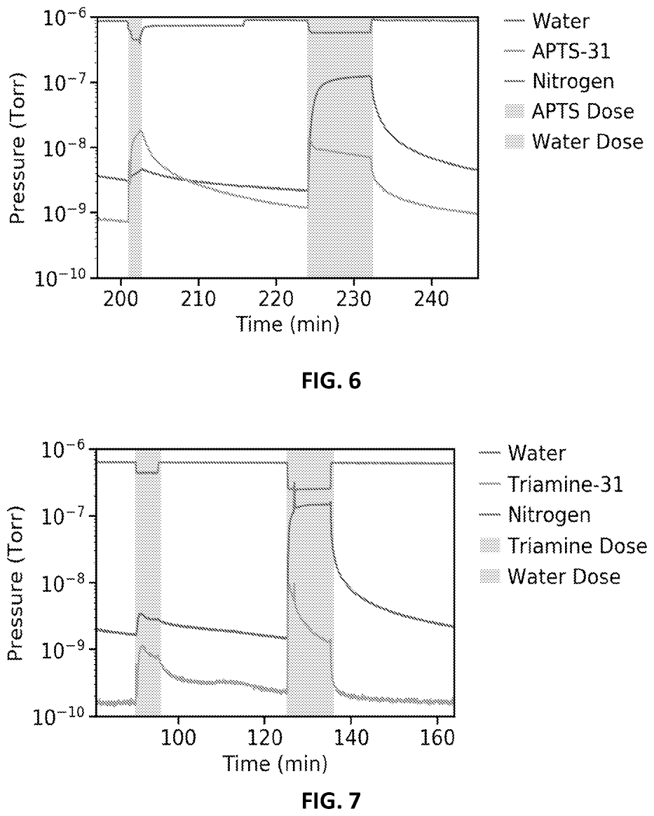

In the mass spectrometry (MS) trace for the mono-amine MLD shown in FIG. 6, there is proof of gas phase reactions for both of the reagent doses. Reactions occurred between (1) the aminopropyl-silane precursor molecule and the hydroxyl groups on the silica surface to produce ethanol or methanol as a byproduct, and (2) between water and the alkoxy groups of the deposited amine molecule to also produce ethanol or methanol as the leaving group. In the MS traces, the APTS-31 curve is the primary peak associated with the mono-amine. During the water dose in, the APTS-31 peak has an initial surge, followed by a change in slope ˜1 minute later. The change in slope followed by a plateauing trend indicates surface saturation of the water/ethoxy reactions. Additionally, due to the coupled nature of MLD reactions, the apparent reaction between water and some functional group indicates that some deposition of the mono-amine occurred on the surface prior to the water dose.

Alternatively, saturation of the surface was also deduced in the trace by the considerably large, and rapidly increasing APTS-31 trace at the beginning of the dose. Similarly, FIG. 7 is an example of a successful tri-amine/water MLD cycle to deposit an alkylamine network. The triamine-31 signal is most directly correlated with the tri-amine precursor. The initial surge in the triamine-31 signal followed by plateauing behavior during the tri-amine dose indicated surface saturation.

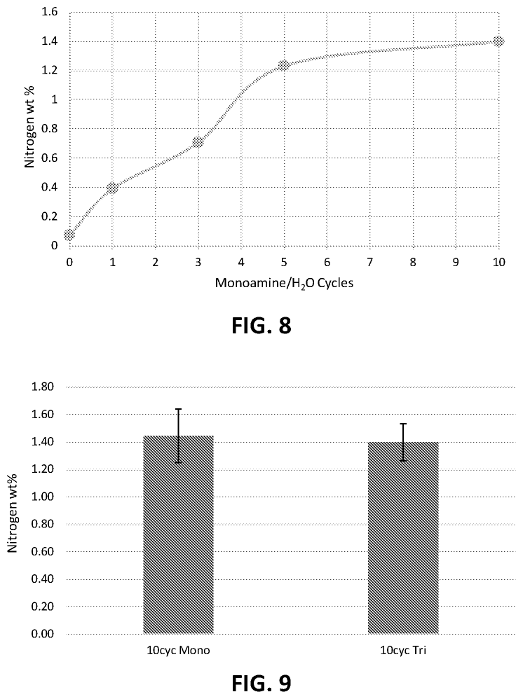

Nitrogen weight percent vs. cycle number data of the mono-amine and tri-amine sorbent materials presented further confirmation of the success and controllability of each of the MLD chemistries, as presented in at least FIG. 8 and FIG. 9. The nitrogen weight percent of the coated SiO₂ samples increases from approximately 0.1% in the uncoated (zero cycles) sample to 1.42% over the addition of 10 cycles. 10 cycles of the tri-amine also has a weight percent of 1.40%. Therefore, both MLD chemistries were successful in depositing the alkylamine ligands.

The relationship of nitrogen content vs. mono-amine cycles also demonstrates an exponential trend from one to ten cycles, indicating potential surface saturation of MLD precursors at larger cycle numbers. Therefore, nitrogen content, proportional to the number of amine groups, of a CO₂ sorbent can be directly controlled by the number of MLD cycles.

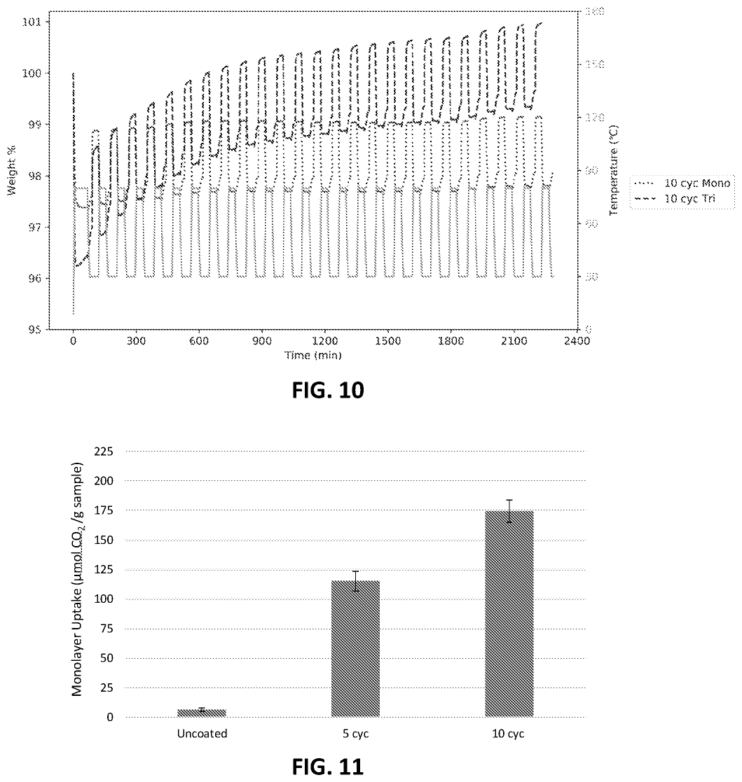

Thermal cycling between the desorption and adsorption temperature ranges was conducted for 25 cycles of both the 10-cycle mono-amine and 10-cycle tri-amine samples. Both 10-cycle samples adsorbed and desorbed CO₂ in the aforementioned temperature ranges (FIG. 10). Adsorption is confirmed by the sharp increase in weight percent of the sample upon exposure to CO₂ and desorption was confirmed by the decrease of that peak.

Both sorbents demonstrated the ability to regenerate amine active sites based on the constant amplitude in the mass percent change peaks over 25 cycles. If the amplitudes of subsequent peaks were to fall off/decrease, there would be evidence for amine group loss during the desorption steps. Therefore, MLD-synthesized, CO₂ capture sorbents according to the present disclosure are able to regenerate within the desorption temperature range without noticeable depletion in amine groups.

MLD deposits an amine network that increases monolayer uptake of CO₂ with increasing cycle numbers, which is also similar to the nitrogen content trend. The uncoated fumed silica exhibits a monolayer uptake of approximately 6.22 μmol CO₂/g sorbent, 5 cycles of the mono-amine adsorbs 115 μmol CO₂/g sorbent, and 10 cycles adsorbs 174 μmol CO₂/g sorbent (FIG. 11). The increasing number of alkylamine ligands deposited by subsequent MLD cycles provides increased active sites for CO₂ adsorption.

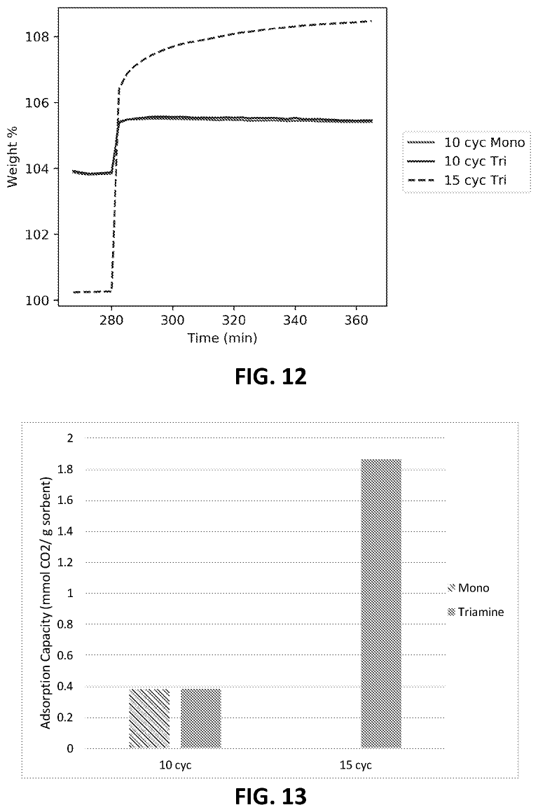

Absolute adsorption capacity also increases with cycle number. The 15-cycle triamine sorbent exhibits a significantly larger mass increase upon the introduction to a CO₂ gas stream in comparison to the 10-cycle sorbent as seen in the TGA traces (FIG. 12). The adsorption capacity of a sorbent can be calculated from the mass change at 280 minutes in the TGA experiments by converting change in mass percent into mass using the initial mass of the sorbent, converting mass into mol of CO₂, and dividing by the initial mass of the sorbent. The adsorption capacities were 0.382 mmol CO₂/g sorbent and 1.86 mmol CO₂/g sorbent, for 10 and 15 cycles of the tri-amine MLD, respectively, as presented in FIG. 13. MLD was successful in coating the silica substrate and increasing the adsorption capacity of the synthesized sorbents by increasing the cycle number.

The present disclosure can be embodied in other specific forms without departing from its spirit or essential characteristics. Thus, the described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

It is to be understood that not necessarily all objects or advantages may be achieved under any embodiment of the disclosure. Those skilled in the art will recognize that the disclosed amine-functionalized solid sorbent and related methods may be embodied or carried out in a manner that achieves or optimizes one advantage or group of advantages as taught without achieving other objects or advantages as taught or suggested.

The skilled artisan will recognize the interchangeability of various disclosed features. Besides the variations described, other known equivalents for each feature can be mixed and matched by one of ordinary skill in this art to make or use an amine-functionalized solid sorbent under principles of the present disclosure. It will be understood by the skilled artisan that the features described may be adapted to other sorbent functionalization and related processes.

1. A method of forming an amine-functionalized solid CO₂ sorbent comprising:
providing a support material; and
applying an amine layer onto at least a portion of a surface of the support material by performing at least one cycle of molecular layer deposition (MLD) with a first precursor and a second precursor,
wherein the first precursor comprises an amine precursor.

2. The method of claim 1, wherein the first precursor comprises an aminopropyl-silane.

3. The method of claim 2, wherein the first precursor comprises aminopropyltriethoxysilane (mono-amine or APTS), N¹-(3-trimethoxysilylpropyl) diethylene triamine (tri-amine), and/or N-[3-(trimethoxysilyl) propyl] ethylenediamine (di-amine).

4. The method of claim 1, wherein the second precursor comprises water.

5. The method of claim 1, wherein between the first precursor and the second precursor the surface of the support material is purged with nitrogen gas.

6. The method of claim 1, wherein the support material comprises a silica-based support material, the silica-based support material comprising fumed silica, silica fume, porous silica, mesoporous silica, silica gel, silica aerogel, silica nanotubes, and/or silica foam.

7. The method of claim 1, wherein the support material comprises alumina, titanium, zirconia, metal-organic frameworks, polymers, carbon nanotubes/fibers, zeolites, carbon black, carbon particles and/or activated carbon.

8. The method of claim 1, wherein at least 5 cycles of MLD are performed.

9. The method of claim 1, wherein at least 10 cycles of MLD are performed.

10. The method of claim 1, the support material comprises a nano-powder.

11. An amine-functionalized solid CO₂ sorbent comprising:
a support material;
an amine layer; and
wherein the amine layer forms chemical bonds to the support material.

12. The amine-functionalized solid CO₂ sorbent of claim 11, wherein the amine layer has a thickness corresponding to at least one cycle of molecular layer deposition (MLD) with a first precursor and a second precursor.

13. The amine-functionalized solid CO₂ sorbent of claim 12, wherein the thickness of the amine layer corresponds to at least five cycles of MLD.

14. The amine-functionalized solid CO₂ sorbent of claim 12, wherein the support material is a porous material, and a total surface area of the support material is coated with the amine layer.

15. The amine-functionalized solid CO₂ sorbent of claim 12, wherein the support material comprises a nano-powder.

16. The amine-functionalized solid CO₂ sorbent of claim 12, wherein the first precursor comprises an aminopropyl-silane.

17. The amine-functionalized solid CO₂ sorbent of claim 16, wherein the first precursor comprises aminopropyltriethoxysilane (mono-amine or APTS), N¹-(3-trimethoxysilylpropyl) diethylene triamine (tri-amine), and/or N-[3-(trimethoxysilyl) propyl] ethylenediamine (di-amine).

18. The amine-functionalized solid CO₂ sorbent of claim 12, wherein the second precursor comprises water.

19. The amine-functionalized solid CO₂ sorbent of claim 11, wherein the support material comprises a silica-based support material, the silica-based support material comprising fumed silica, silica fume, porous silica, mesoporous silica, silica gel, silica aerogel, silica nanotubes, and/or silica foam.

20. The amine-functionalized solid CO₂ sorbent of claim 11, wherein the support material comprises alumina, titanium, zirconia, metal-organic frameworks, polymers, carbon nanotubes/fibers, zeolites, carbon black, carbon particles and/or activated carbon.
